(19) United States
(12) Patent Application Publication
(10) Pub. No.: US 2004/0017647 A1
(43) Pub. Date: Jan. 29, 2004

(54) Electrical double-layer capacitor

(75) Inventors: Tetsushi Okamoto, Kanagawa-ken (JP); Kentaro Matsunaga, Kanagawa-ken (JP); Kazuhiro Nakajima, Tokyo (JP); Tokihiro Umemura, Mie-ken (JP); Hideki Tanaka, Tokyo (JP); Sadao Ida, Saitama-ken (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/373,206

(22) Filed: Feb. 26, 2003

(30) Foreign Application Priority Data
Feb. 27, 2002 (JP) P2002-051507

(51) Int. Cl. H01G 9/00

(52) U.S. Cl. 361/502

(57) ABSTRACT

An electrical double-layer capacitor has a construction wherein a pair of positive and negative polarizing electrodes whose chief constituent is active carbon laminated (or coiled) in a condition with a separator sandwiched therebetween and with their outsides held by respective aluminum collection electrodes are accommodated in a case made of metal etc. in a condition impregnated with electrolyte using propylene carbonate as solvent. The polarizing electrodes have a solid-state structure wherein the active carbon particles are the chief constituent (first substance) and these active carbon particles 3 are connected in network fashion by a second substance such as for example nano-size carbon black which is of higher electrical conductivity than the active carbon and of smaller size than the active carbon particles.

### CROSS REFERENCE TO RELATED APPLICATION

This application claims benefit of priority to Japanese Application No. JP 2002-51507 filed Feb. 27, 2002, the entire content of which is incorporated by reference herein.

### BACKGROUND OF THE INVENTION

1. Field of the Invention

The present invention relates to an electrical double-layer capacitor (or electrical double layer capacitor) employing active carbon as the polarizing electrodes.

2. Description of the Related Art

In a typical construction of an electrical double-layer capacitor (EDLC) of this type, a separator interposed between a pair of polarizing electrodes is impregnated with electrolyte and accommodated in a case in laminated or coiled form. In this case, conventionally, the chief constituents of the polarizing electrodes were for example activated active carbon and carbon black (first substance); to these was added an additive (resin) etc. constituting a binder and the resulting mixed material was used to form a thin sheet on aluminum collection electrodes.

However, in such an EDLC, due to the construction etc. of the polarizing electrodes, there is an internal resistance of a certain magnitude and, depending on the application, this internal resistance can become a problem. Various expedients have therefore been adopted to lower the resistance of the polarizing electrodes, such as for example as shown in Japanese Patent No. 2830253, a construction in which active carbon and meso-carbon etc. are mixed and sintered to produce an electrode body, or, as shown in Japanese Patent No. 2604547, a composition in which active carbon particles of large particle size and active carbon particles of smaller particle size, 25% or less, are mixed therewith, or, as shown in Japanese Patent No. 3132181, a composition in which an equal or lesser amount of conductive material is combined with particles of active carbon or carbon black.

However, with expedients as described above for lowering the resistance of the polarizing electrodes, the internal resistance can at most only be lowered by about 20 mΩ so, in particular, in applications such as performing power control at high speed, resistance losses due to the controlling current are considerable, causing a rise in temperature and deterioration etc. In the development of EDLC cells this therefore presented an obstacle to reducing the size or improving the efficiency of the equipment in which these were used.

### SUMMARY OF THE INVENTION

Accordingly, one object of the present invention is to provide a novel electrical double-layer capacitor applicable to charging and discharging large power at high speed and wherein a considerable reduction in internal resistance can be achieved.

In order to achieve the above object, the present invention is constituted as follows. Specifically, an electrical double-layer capacitor according to the present invention has a structure wherein as the solid-state structure of the polarizing electrodes, active carbon particles constituting the chief constituent (first substance) are connected in network fashion by a second substance whose electrical conductivity is higher than that of the active carbon and which is of smaller size than said active carbon particles. Thus, the resin (or electrolyte) in the gap portions between adjacent active carbon particles (and between the active carbon and the collection electrodes) is so-to-speak substituted by the second substance of smaller particle size and higher electrical conductivity, so the active carbon particles which are the main constituent (chief constituent) of the polarizing electrodes are connected by the second substance of higher electrical conductivity, thereby making it possible to increase the number of connection points (paths) and so lower the internal resistance.

With the foregoing, the electrical resistance of a composite material in which active carbon particles are dispersed in resin changes depending on the volumetric ratio (packing amount) of the active carbon but, as shown in FIG. 2, the relationship is such that, when a certain volumetric ratio is exceeded, the electrical resistance abruptly falls (region B) and, further, when the packing amount of the active carbon particles becomes large, shows a gradual fall (region C). It is believed that, in this region in which the electrical resistance shows a gradual fall, infinite clusters of active carbon are formed in the composite material so that a network (percolation paths) is produced. This region C is a region in which the electrical resistance changes depending on the number of paths that are formed by the active carbon.

Consequently, in polarizing electrodes whose chief constituent is active carbon particles, in order to lower the electrical resistance, it is important to increase the number of paths. In the following description, the active carbon particles will be referred to as the first substance. However, since the active carbon particles have a particle size of at least a certain magnitude, and a substance of low electrical conductivity, namely, resin (binder) or electrolyte is present in the gaps between the active carbon particles, even if the packing amount of the active carbon particles in the volume is large, the gaps between adjacent active carbon particles (and between active carbon particles and the collection electrodes) will be comparatively large, so the paths must pass through a comparatively small number of portions where there is point contact between adjacent active carbon particles, so it is not possible to achieve sufficient reduction in internal resistance. BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

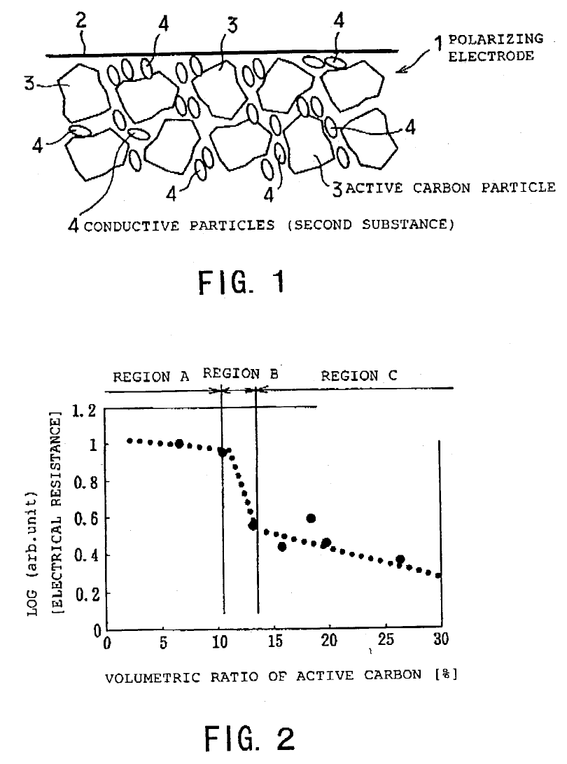

FIG. 1 is a view showing a first embodiment of the present invention, showing schematically the solid-state structure of a polarizing electrode;

FIG. 2 is a view showing the relationship of the volumetric ratio of active carbon and the electrical resistance in a composite material in which active carbon particles are dispersed in resin;

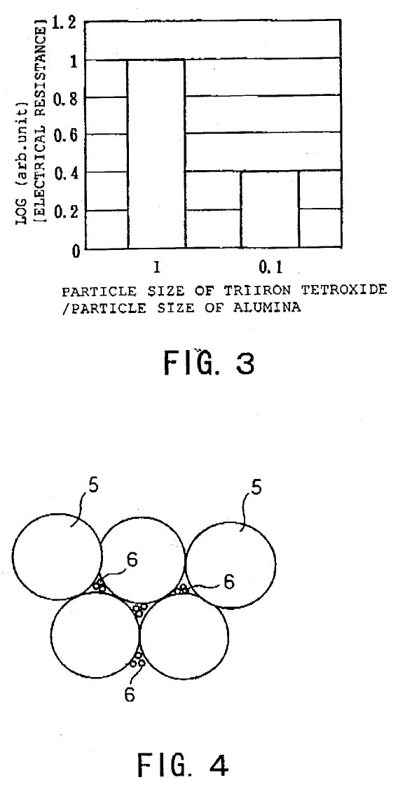

FIG. 3 is a view showing the results of measurement of resistance of material of two types in which alumina and triiron tetroxide are dispersed, the particle sizes thereof being varied;

FIG. 4 is a view showing how gaps are formed when alumina particles are close-packed;

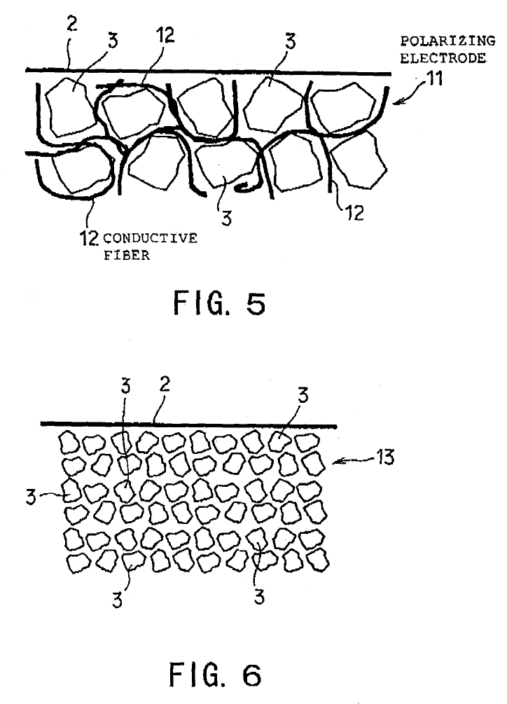

FIG. 5 is a view corresponding to FIG. 1, showing a second embodiment of the present invention;

FIG. 6 is a view showing a polarizing electrode constituted by laminating six layers of active carbon particles;

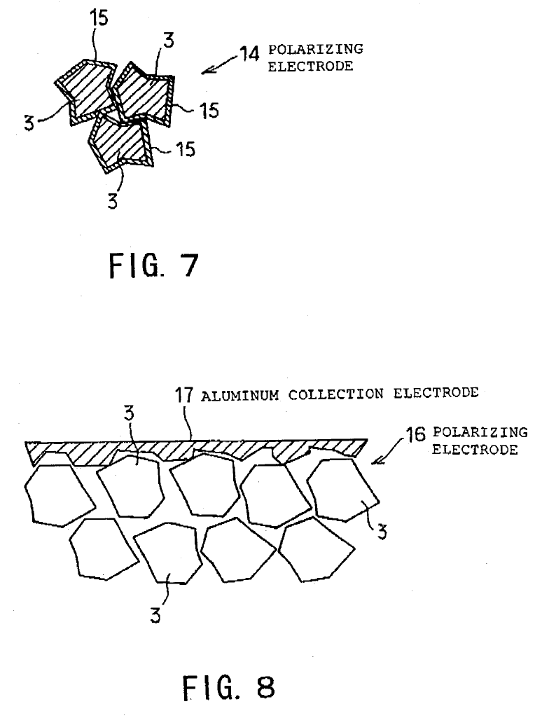

FIG. 7 is a view showing a third embodiment of the present invention, showing schematically the bonded condition of active carbon particles;

FIG. 8 is a view corresponding to FIG. 1, showing a fourth embodiment of the present invention;

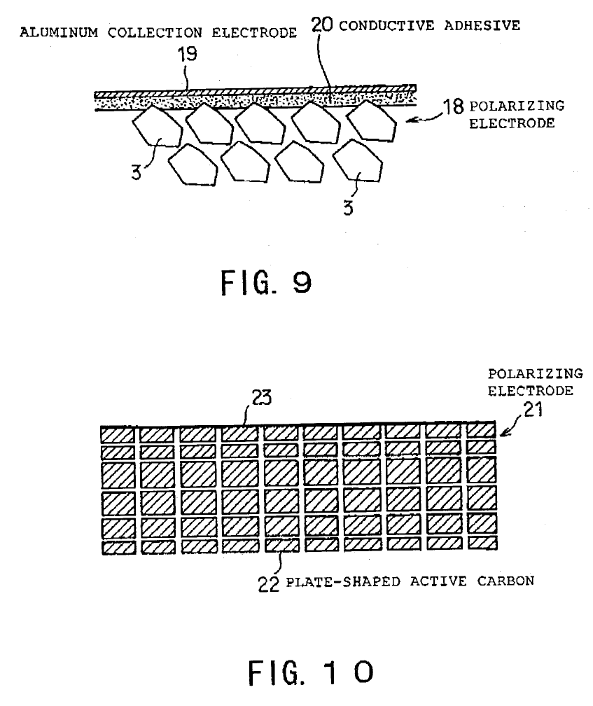

FIG. 9 is a view corresponding to FIG. 1, showing a fifth embodiment of the present invention;

FIG. 10 is a view corresponding to FIG. 1, showing a sixth embodiment of the present invention; and

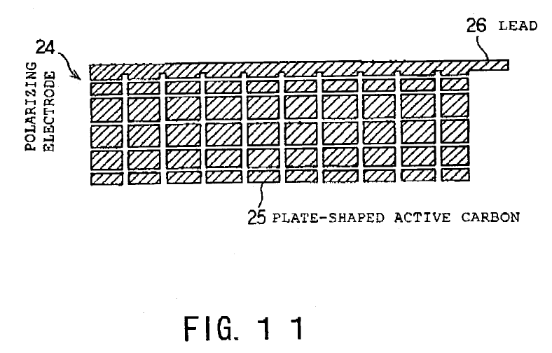

FIG. 11 is a view corresponding to FIG. 1, showing a seventh embodiment of the present invention,

### DETAILED DESCRIPTION OF THE PREFERRED EMBODIMENTS

Referring now to the drawings, wherein like reference numerals designate identical or corresponding parts throughout the several views, and more particularly to FIG. 1 thereof, one embodiment of the present invention will be described.

(1) First Embodiment

First of all, a first embodiment of the present invention is described with reference to FIG. 1 to FIG. 4.

FIG. 1 is a view showing schematically the solid-state structure of a polarizing electrode 1 in an electrical double-layer capacitor according to an embodiment of the present invention. Although not shown in the drawing, this electrical double-layer capacitor is constructed by accommodating, in laminated (or coiled) condition, a pair of positive and negative polarizing electrodes 1 whose chief constituent is active carbon, in a condition sandwiching a separator therebetween and with carriers (backing) provided by respective aluminum collection electrodes 2 on the outside thereof, in a case made of metal etc., in a condition impregnated with an electrolyte employing for example propylene carbonate as solvent.

Although the chief constituent of the polarizing electrodes 1 is active carbon particles 3, these active carbon particles 3 have a solid-state structure that is connected in network fashion by means of a second substance of higher conductivity than the active carbon and of smaller size than the active carbon particles 3. Based on the experiments and studies of the present inventors, in this embodiment, carbon black 4 (called “nano-carbon black 4”) of nano size, whose conductive particles have a particle size of less than 0.15 times the particle size of the active carbon particles 3, is employed as the second substance.

It should be noted that, in this case, although the particles of the nano-carbon black 4 are of primary particle size less than 100 nm, they generate agglomerations and these agglomerations are of diameter less than 0.15 times the particle size of the active carbon particles 3. Also, in this embodiment, the particle size of the active carbon particles 3 is about 50 μm.

The aforesaid polarizing electrodes 1 are obtained by for example mixing active carbon particles 3 and nano-carbon black 4 with an additive (resin) or the like as a binder and then applying this mixture using a blade to aluminum collection electrodes 2 made of aluminum foil and drying. The thickness of the resulting layer is made to be for example about 100 μm.

In an electrical double-layer capacitor according to this embodiment having such polarizing electrodes 1, the internal resistance can be reduced to about ½ that of a conventional electrical double-layer capacitor. The reasons for this will now be examined. That is, as shown in FIG. 2, the Relationship with which the electrical resistance of a composite material in which active carbon particles are dispersed in a resin changes in accordance with the volumetric ratio (filling amount) of active carbon is such that, when a certain volumetric ratio is exceeded, the electrical resistance drops abruptly (region B) and when the filling amount of active carbon particles is further increased, falls gradually (region C). It is believed that networks (percolation paths) are produced by the formation of infinite clusters of active carbon in the composite material in the region C in which this gradual fall of electrical resistance takes place. This region C is a region in which the electrical resistance changes depending on the number of paths that are formed by the active carbon.

Consequently, for polarizing electrodes whose chief constituent is active carbon particles, in order to lower the electrical resistance, it is important to increase the number of paths. However, since the active carbon particles have at least a certain degree of particle size and a substance of low electrical conductivity such as resin (binder) or electrolyte is present in the gaps between the active carbon particles, even if the filling amount of the active carbon particles in the volume is large, the gaps between adjacent active carbon particles (and between active carbon and the collection electrodes) are comparatively large, so the paths have to pass through point contact portions of adjacent active carbon particles which are comparatively few in number, so it is not possible to achieve sufficient reduction of the internal resistance.

In contrast, with the polarizing electrodes 1 of this embodiment, the resin (or electrolyte) in the gap portions between the active carbon particles 3 (and between the active carbon particles 3 and the aluminum collection electrodes 2) is so-to-speak replaced by nano-carbon black 4 of high conductivity and small particle size. It is believed that the active carbon particles 3 which are the chief constituent of the polarizing electrodes 1 are therefore connected by the nano-carbon black 4, making it possible to increase the number of contact points (paths) and lowering internal resistance. Also in this case it is believed that an excellent effect in reducing the internal resistance is manifested due to cluster growth through the aforesaid gaps of even a small quantity of nano-carbon black 4, since this easily tends to form of agglomerations.

However, in an electrical double-layer capacitor of this type, the electrostatic capacitance is determined by the amount of active carbon, so it is undesirable in regard to performance to lower the amount of active carbon particles 3. Also, since, as described above, reduction in the internal resistance is achieved by filling up the gap portions between adjacent active carbon particles 3 with the second substance, the resistance can be made lower as this second substance is made smaller; it is believed that, in this case, it is necessary that the size of the second substance should be at most smaller than the size of the active carbon particles 3. The inventors conducted the following experiments to verify this by example.

Specifically, these experiments were conducted using, instead of the active carbon particles, alumina particles of higher resistance and using, as the second substance, instead of the nano-carbon black, triiron tetroxide, by measuring the resistance of samples in which alumina of particle size 1 μm and triiron tetroxide of particle size 1 μm were dispersed in resin and samples in which alumina of particle size 10 μm and triiron tetroxide of particle size 1 μm were dispersed in resin. The results are shown in FIG. 3.

From these results, it was found that the resistance was higher if the particle size of the triiron tetroxide (second substance) was made of the same order as that of the alumina but the resistance could be made smaller by making the particle size of the triiron tetroxide smaller than the particle size of the alumina. The reason for this is believed to be that, if the particle size of the alumina is close to the particle size of the triiron tetroxide, the gaps of the networks that are formed by the alumina are comparatively small, so the triiron tetroxide particles form conductive paths through a fine network; as a result, for equal contents of triiron tetroxide, the conductive path of the triiron tetroxide becomes longer, increasing the resistance.

Furthermore, according to the experiments and studies of the present inventors, as shown in FIG. 4, the gaps formed when the alumina particles 5 are close-packed are of the order of 0.15 times the size of the alumina particles. If therefore the particle size of the triiron tetroxide particles 6 exceeds 0.15 times the alumina particles, the triiron tetroxide particles 6 cannot pass through the gaps between the alumina particles 5, so the resistance is increased. That is, by making the particle size of the triiron tetroxide particles 6 less than 0.15 times that of the aluminum particles 5, even when the alumina particles 5 are close-packed, the electrical resistance can be considerably reduced.

This test is exactly the same if the alumina particles 5 are replaced by active carbon particles 3, so, if conductive particles of particle size less than 0.15 times the particle size of the active carbon 3 are adopted as the aforesaid second substance, without reducing the filling amount of the active carbon particles 3, the second substance (conductive particles) can be reliably embedded in the gaps between adjacent active carbon particles 3, and is therefore effective in lowering the internal resistance.

It should be noted that it would also be possible to employ metallic nano-particles etc. of high electrical conductivity instead of the nano-size carbon black 4 as the conductive particles (second substance) in this case. Also, although not illustrated or described in detail, carbon nano-tubes having an external diameter (for example 30 nm) of less than 0.15 times the particle diameter of the active carbon could be employed as the second substance. By this means also, an excellent reduction in the internal resistance of the polarizing electrodes can be achieved.

(2) Second Embodiment

FIG. 5 and FIG. 6 illustrate a second embodiment of the present invention.

As shown in FIG. 5, with an electrical double-layer capacitor according to the second embodiment also, polarizing electrodes 11 that are held on aluminum collection electrodes 2 and whose chief constituent is active carbon particles 3 are provided, but, in this embodiment, as the second substance, conductive fibers constituted by stainless steel fibers 12 are employed.

The thickness (diameter) of the stainless-steel fibers 12 in this case is less than 0.15 times the particle size of the active carbon particles 3 and their length is about the same or more, or, in this case, twice or more, the thickness of the layer of the polarizing electrodes 11 (for example 100 μm). These polarizing electrodes 11 also are obtained by mixing (kneading) active carbon particles 3 and stainless-steel fibers 12 with an additive (resin) etc. constituting a binder, the resulting mixture being then applied using a blade onto aluminum collection electrodes 2 made of aluminum foil and dried.

With this composition, an excellent effect in reducing the internal resistance can be achieved thanks to reduction in the number of contact interfaces in the thick mist direction of the layer of the polarizing electrodes 11, by mixing long stainless-steel fibers 12 of highly electrical conductivity with the polarizing electrodes 11. In this case, as shown in FIG. 6, considering the case of polarizing electrodes 13 obtained by laminating six layers of active carbon particles 3, a thin resin layer or electrolyte layer is formed at the interfaces of the active carbon particles 3, so, when current flows in the thickness direction, the current has to flow through at least seven interfaces, but, by the admixture of the stainless-steel fibers 12, the contact interface locations can be reduced to two and a very considerable reduction in the internal resistance thereby achieved.

According to the experiments of the inventors, with the polarizing electrodes 11 of this embodiment, it was found to be possible to reduce the volumetric resistivity by a factor of 0.2 (⅕) compared with conventional polarizing electrodes whose chief constituents were active carbon and carbon black. As the conductive fibers, apart from the stainless-steel fibers 12 described above, various other types of fibers could be employed such as carbon fibers or nickel fibers or aluminum fibers.

(3) Third Embodiment

FIG. 7 shows a third embodiment of the present invention.

The chief constituent of the polarizing electrodes 14 of this embodiment is likewise active carbon particles 3, but the surface of these active carbon particles 3 is given a coating 15 of a substance of high electrical conductivity such as for example gold. As the second substance, for example particles of high electrical conductivity may include nano-particles (not shown) of gold of 3 nm.

To manufacture these polarizing electrodes 14, active carbon particles given beforehand a coating 15 of gold may be mixed and stirred with gold nano-particles and heated at for example about 300° C. Since the nano metal particles have a low melting point, they melt at about 300° C. and bond with the gold coating 15 of the active carbon particles 3, making it possible to greatly lower the contact resistance at the interface and hence to achieve a considerable reduction in the internal resistance. In this embodiment, in comparison with a case in which no gold coating 15 is provided, the internal resistance was lowered by a factor of about ⅓.

(4) Fourth Embodiment

FIG. 8 shows a fourth embodiment of the present invention.

In this embodiment, polarizing electrodes 16 whose chief constituent is active carbon particles 3 and including a second substance (not shown) are held on an aluminum collection electrodes 17; the carrier surface of these aluminum collection electrodes 17 (undersurface in the Figure) is subjected to surface roughening treatment so that it is formed with minute irregularities. Physical or electrochemical etching may be adopted as the method of this surface roughening treatment.

With such a construction, the contact area of the active carbon particles 3 (or second substance) and the aluminum collection electrodes 17 can be made larger than in the case where the surface roughing treatment is not performed i.e. in the case where there is point contact between the aluminum collection electrodes and the particles. The internal resistance can therefore be reduced. In this embodiment, a reduction in internal resistance to about ½ compared with the case where there was no surface roughening treatment was achieved.

(5) Fifth Embodiment

FIG. 9 shows a fifth embodiment of the present invention.

In this embodiment, polarizing electrodes 18 including a second substance (not shown), whose chief constituent is active carbon particles 3, are stuck on using electrically conductive adhesive 20 when they are held on the aluminum collection electrodes 19. In this way, the resistance at the interface between the polarizing electrodes 18 and the aluminum collection electrodes 19 can be reduced and the internal resistance thereby decreased. In this embodiment the resistance was lowered by about 20% compared with the case where electrically conductive adhesive 20 was not employed.

(6) Sixth Embodiment

FIG. 10 shows schematically the construction of a polarizing electrode 21 of an electrical double-layer capacitor according to a sixth embodiment of the present invention.

The chief constituent of this polarizing electrode 21 is porous plate-shaped active carbon or porous plate-shaped carbon 22; this plate-shaped active carbon or porous plate-shaped carbon 22 is connected with aluminum collection electrodes 23. This porous plate-shaped active carbon or porous plate-shaped carbon 22 can be obtained by converting a polymer film (for example a polyimide film) into porous form by the method of partially dissolving the polymer, thereby obtaining a porous structure (porous polyamide film), then graphitizing this porous structure at for example 2000° C. and then further subjecting it to steam activation treatment.

Methods of manufacturing porous plate-shaped active carbon or porous plate-shaped carbon 22 as described above include the method of mixing two types of polymer material and separating a micro-layer, then converting to porous form by removing one of the resins, thus obtaining a porous structure, which porous structure is then carbonized, or the method of forming an island structure using block copolymer, then converting to porous form by removing one of the resins to obtain a porous structure, which porous structure is then carbonized. Such a method of obtaining a porous structure is described in detail in Laid-open Japanese Patent Publication Number 2001-151834 applied for previously by the present applicants, so a detailed description thereof is omitted.

Since such polarizing electrodes 21 according to this embodiment are constituted of porous plate-shaped active carbon or porous plate-shaped carbon 22, the interfaces between particles such as are found when active carbon particles are employed are absent, so the internal resistance can be greatly reduced. According to the tests performed by the present inventor, the polarizing electrodes 21 of this embodiment had a volumetric resistivity of about 1/10 that of conventional polarizing electrodes whose chief constituents were active carbon and carbon black.

(7) Seventh Embodiment

FIG. 11 shows a seventh embodiment of the present invention.

The polarizing electrodes 24 in this embodiment are likewise constituted of porous plate-shaped active carbon or porous plate-shaped carbon material 25 but in this case leads 26 for connection are integrally formed with the plate-shaped active carbon material 25. In this case, an active carbon electrode 25 having an integral lead 26 can be manufactured by for example forming plate-shaped active carbon material of large dimensions beforehand and cutting from this plate-shaped active carbon material. It should be noted that, in this embodiment, with the integral formation of the lead 26 on the polarizing electrode 24, the aluminum collection electrodes are dispensed with.

In electrical double-layer capacitors, the resistance of the leads has a considerable effect on the internal resistance. In particular, this resistance becomes a problem since the number of leads increases as the number of layers of the polarizing electrode increases; thus, when employed in power applications etc., it is necessary to lower the internal resistance, including that of the leads. In this embodiment, the leads 26 for connection are integrally formed with the plate-shaped active carbon material 25 (polarizing electrode 24), so reduction in the total internal resistance including that of the leads can be achieved. In this embodiment, a reduction of the total internal resistance to less than 1 mΩ was achieved.

It should be noted that the present invention is not restricted to the embodiments described above and could be put into practice in suitably modified ways without departing from its essence and a plurality of the embodiments described above could be combined. For example, the polarizing electrodes 14 of the third embodiment could be arranged to be held on aluminum collection electrodes 17 subjected to surface roughening treatment as in the fourth embodiment, or the polarizing electrodes 21 of the sixth embodiment could be stuck on to the aluminum collection electrodes 23 using the conductive adhesive 20 of the fifth embodiment.

As will be clear from the above description, with an electrical double-layer capacitor according to the present invention, thanks to the adoption of a solid-state construction of the polarizing electrodes wherein active carbon particles (first substance) constituting the chief constituent are connected in network fashion by a second substance whose conductivity is higher than that of the active carbon and which is of smaller size than the active carbon particles or thanks to the adoption of a construction of the polarizing electrodes in which porous plate-shaped active carbon or porous plate-shaped carbon is the chief constituent, the excellent benefit is obtained that considerable reduction in the internal resistance can be achieved, making it possible to apply this for high-speed charging/discharging of large power.

Obviously, numerous additional modifications and variations of the present invention are possible in light of the above teachings. It is therefore to be understood that within the scope of the appended claims, the present invention may be practiced otherwise than as specially described herein.

What is claimed is:

1. An electrical double-layer capacitor, comprising:
at least a pair of polarizing electrodes;
wherein said polarizing electrodes have a solid-state structure in which a particle of an active carbon constituting a first substance and constituting a chief constituent is connected in network fashion by a second substance whose electrical conductivity is higher than a size of said active carbon and which is of smaller size than said active carbon particle.

2. The electrical double-layer capacitor according to claim 1,
wherein said second substance is electrically a conductive particle of particle size less than 0.15 times size of an active carbon particle.

3. The electrical double-layer capacitor according to claim 1,
wherein said second substance is carbon nano-tubes having an external diameter of less than 0.15 times a particle size of said active carbon particle.

4. The electrical double-layer capacitor according to claim 1,
wherein said second substance is electrically a conductive fiber which has a thickness of less than 0.15 times a particle size of an active carbon particle and a length which is the same as or more than a thickness of a polarizing electrode layer.

5. The electrical double-layer capacitor according to any of claims 1 to 4,
wherein a surface of said active carbon particle is coated with a substance of a higher electrical conductivity than said active carbon particle.

6. The electrical double-layer capacitor according to any of claims 1 to 4,
wherein said polarizing electrodes are held on an aluminum collection electrode and a holding surface of said aluminum collection electrode is subjected to a surface roughing treatment.

7. An electrical double-layer capacitor, comprising;
at least a pair of polarizing electrodes;
wherein said polarizing electrodes are chiefly constituted of a porous plate-shaped carbon.

8. The electrical double-layer capacitor according to claim 7,
wherein said porous plate-shaped carbon is obtained by converting a polymer film to a porous form by a polymer partial solution method, followed by carbonization.

9. The electrical double-layer capacitor according to claim 7,
wherein said porous plate-shaped carbon is obtained by stirring polymers of two types and separating a micro-layer, then converting to a porous form by removing one of polymers, followed by carbonization.

10. The electrical double-layer capacitor according to claim 7,
wherein said porous plate-shaped carbon is obtained by forming an island structure using a block copolymer, then converting to a porous form by removing one of resins, followed by carbonization.

11. The electrical double-layer capacitor according to claim 7,
wherein said porous plate-shaped carbon is integrally formed with a lead for connection purposes.

12. The electrical double-layer capacitor according to claim 1,
wherein said polarizing plate-shaped electrodes are held on an aluminum collection electrode by sticking by using electrically conductive adhesive.
